(19) United States
(12) Patent Application Publication
(10) Pub. No.: US 2016/0018528 A1
(43) Pub. Date: Jan. 21, 2016

(54) LOW SPEED HEADING MEASUREMENT WITH BUFFER

(71) Applicant: Ag Leader Technology, Ames, IA (US)

(72) Inventors: Michael Schneider, Ames, IA (US); James D. Yegerlehner, Ames, IA (US)

(21) Appl. No.: 14/798,175

(22) Filed: Jul. 13, 2015

Related U.S. Application Data
(60) Provisional application No. 62/025,552, filed on Jul. 17, 2014.

(51) Int. Cl. G01S 19/13; G01C 21/20

(52) U.S. Cl. CPC G01S 19/13; G01C 21/20

(57) ABSTRACT

A method for determining heading for agricultural equipment operating at low speeds includes receiving a current GNSS position from a GNSS receiver associated with the agricultural equipment, the GNSS receiver having a single antenna, storing a plurality of received GNSS positions, selecting one of the plurality of received GNSS positions whose distance from the current GNSS position exceeds a threshold to provide a selected stored received GNSS position, and calculating heading using the current GNSS position and said selected stored received GNSS position.

### CROSS-REFERENCE TO RELATED APPLICATIONS

This application claims priority to Provisional Application U.S. Ser. No. 62/025,552 filed on Jul. 17, 2014, all of which are herein incorporated by reference in their entirety.

### FIELD OF THE INVENTION

The present invention relates to navigation for agricultural vehicles.

### BACKGROUND OF THE INVENTION

In the navigation of agricultural vehicles there is a need to provide heading measurements. One way heading measurements can be provided is through use of a single antenna receiver connected to the Global Navigation Satellite System (GNSS) of which the Global Positioning System (GPS) is a part. Such a single antenna GNSS system can provide a heading measurement based on vehicle travel direction, but this heading measurement becomes noisy when the vehicle is traveling at low speeds. Therefore, use of a single antenna GNSS system is problematic.

An alternative approach is to use a dual antenna GNSS system. Such a system can provide a good heading measurement at low and zero speed, but such a system adds complexity and significant cost to a control system.

What is needed is an improved low speed heading measurement system.

### SUMMARY OF THE INVENTION

Therefore, it is a primary object, feature, or advantage to improve over the state of the art.

It is a further object, feature, or advantage to provide a heading measurement with acceptable performance at low speeds.

It is a still further object, feature, or advantage to provide a heading measurement without significantly increasing costs or complexity.

It is another object, feature, or advantage to provide for accurate low speed heading measurements without using a dual antenna system.

These and other objects, features, or advantages will become apparent from the specification and claims that follow. No single embodiment need exhibit each and every object, feature, and advantage as it is contemplated that different embodiments may have different objects, features, or advantages.

Agricultural equipment with automatic steering control requires a constantly updated heading measurement for the navigation system. Traditional GNSS receivers produce a heading measurement with every GNSS update, but the error of the heading measurement increases dramatically as vehicle speed falls below 1 mph and approaches zero. This is because the heading measurement is based on the change in vehicle position from one GNSS update to the next, and as speed approaches zero, the change in vehicle position during the GNSS sample period becomes small in relation to GNSS measurement error.

This low speed heading measurement strategy produces a more accurate heading measurement at the same GNSS update rate at all speeds down to zero. It also retains the heading measurement while the vehicle is stopped, and continues to produce a more accurate heading determination as the vehicle starts up again. The improved accuracy of the heading measurement will improve the accuracy of the navigation system and improve steering control.

According to one aspect, a method for determining heading for agricultural equipment operating at low speeds is provided. The method includes receiving a current GNSS position from a GNSS receiver associated with the agricultural equipment, the GNSS receiver having a single antenna. The method further includes storing a plurality of received GNSS positions, selecting one of the plurality of received GNSS positions whose distance from the current GNSS position exceeds a threshold to provide a selected stored received GNSS position, and calculating heading using the current GNSS position and said selected stored received GNSS position.

According to another aspect, a control system for agricultural equipment operating at low speeds is provided. The control system includes a single antenna GNSS receiver, a processor operatively connected to the single antenna GNSS receiver and configured to receive as input from the single antenna GNSS receiver a current GNSS position, and a memory buffer associated with the processor. The processor is configured for (a) receiving a current GNSS position from the GNSS receiver, (b) storing a plurality of received GNSS positions in the memory buffer, (c) selecting one of the plurality of received GNSS positions whose distance from the current GNSS position exceeds a threshold to provide a selected stored received GNSS position, and (d) calculating heading from the current GNSS position and said selected stored received GNSS position.

According to another aspect, a method for determining heading for agricultural equipment operating at low speeds is provided. The method includes receiving a current GNSS position from a GNSS receiver associated with the agricultural equipment, the GNSS receiver having a single antenna and determining by a processor a change in position between a current GNSS position and a most recently stored GNSS position. If the change in position is greater than a threshold, then the methods for incrementing a circular buffer index and storing the current GNSS position in a circular buffer at a location associated with the circular buffer index. The method further provides for calculating heading using the current GNSS position and a most recent GNSS position from the buffer that satisfies a distance requirement.

According to another aspect, a control system for determining heading for agricultural equipment operating at low speeds is provided. The control system includes a single antenna GNSS receiver, a processor operatively connected to the single antenna GNSS receiver and configured to receive as input from the single antenna GNSS receiver a current GNSS position, and a memory buffer associated with the processor. Wherein the processor is configured for receiving the current GNSS position from the single antenna GNSS receiver associated with the agricultural equipment, determining a change in position between the current GNSS position and a most recently stored GNSS position, and if the change in position is greater than a threshold, then incrementing a circular buffer index and storing the current GNSS position in a circular buffer at a location associated with the circular buffer index, and calculating heading using the current GNSS position and a most recent GNSS position from the buffer that satisfies a distance requirement.

### BRIEF DESCRIPTION OF THE DRAWINGS

FIG. 1 illustrates one example of agricultural equipment with a control system.

FIG. 2 illustrates a representation of a circular buffer.

FIG. 3 illustrates one example of a method for updating a circular buffer.

FIG. 4 illustrates one example of a method of calculating a new heading measurement.

### DETAILED DESCRIPTION OF THE PREFERRED EMBODIMENTS

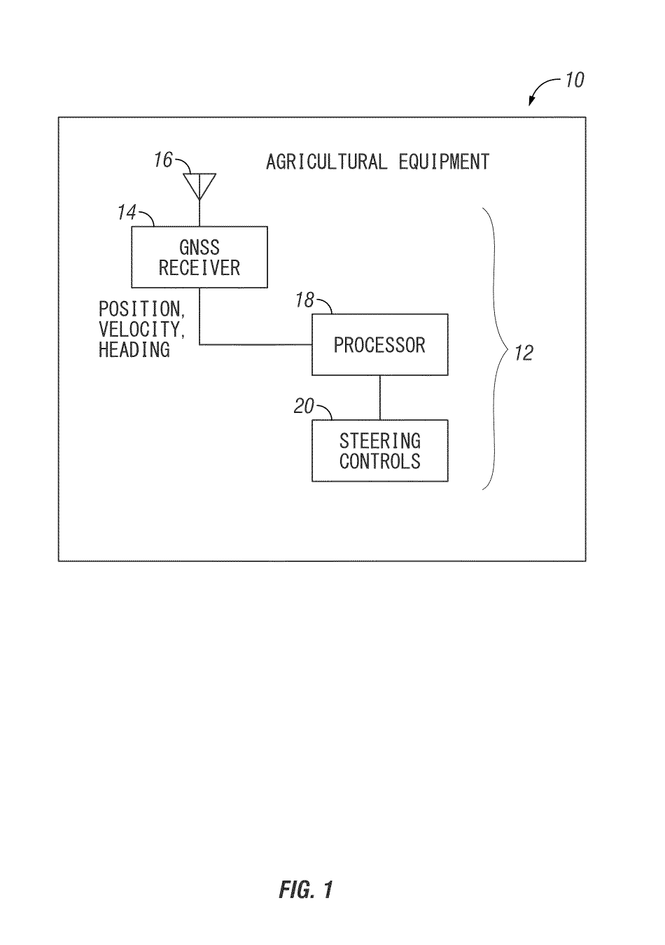

FIG. 1 illustrates one example of agricultural equipment 10 with a control system 12 which provides for navigation. The agricultural equipment 10 may be any number of types of agricultural machines including tractors, sprayers, or other types of machines which may be self-propelled, towed by an agricultural vehicle, or mounted to an agricultural vehicle. The system 12 includes a GNSS receiver 14 with a single antenna 16 associated therewith. The GNSS receiver 14 provides information such as position to a processor 18. The processor 18 may be operatively connected to steering controls 20.

The navigation system for an agricultural vehicle commonly uses GNSS position information which is updated several times per second. When a single GNSS antenna is used, and a heading measurement is needed, the GNSS heading measurement is normally determined from the change in the current and previous position measurements. Given an X-Y coordinate system, the travel direction can be calculated as the arctangent of the signed Y direction change divided by the signed X direction change. If side slip is negligible, the heading will align with travel direction when the vehicle is moving forward, and will be 180 degrees from the travel direction when the vehicle is moving in reverse gear. As the vehicle slows toward zero speed, however, the change in position for one sample period gets very small and becomes small compared to GNSS measurement noise. This leads to increasing measurement error of the travel direction, and therefore of the heading.

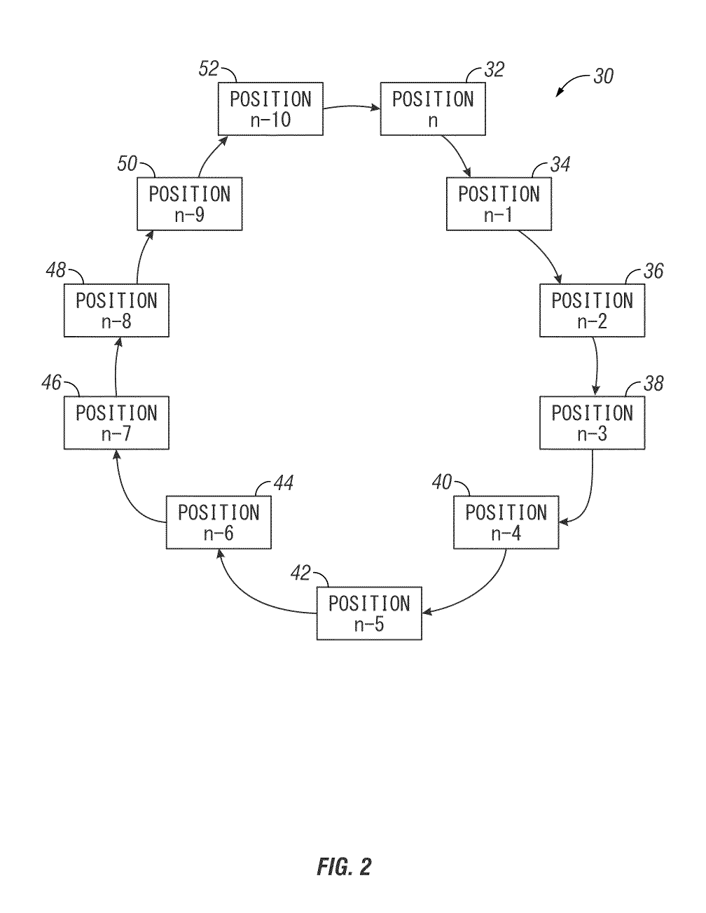

The present invention allows for a new heading which is calculated by the processor using only pairs of GNSS coordinates that represent a sufficient change in position to allow a calculation with acceptable error. To allow recalculation of the heading at every GNSS update at low vehicle speed using the current GNSS coordinates, previous GNSS coordinates that represent a sufficient position change compared to the current position, must be stored in memory. GNSS coordinates are stored in a circular buffer which is updated whenever vehicle travel exceeds a threshold distance beyond the previously stored coordinates. FIG. 2 illustrates one example of a circular buffer 30 where a number of positions (coordinate sets) are stored 32, 34, 36, 38, 40, 42, 44, 46, 48, 50, 52.

Since each set of coordinates represents a distance traveled beyond the previously stored coordinates, the number of coordinate sets in the buffer represents a total distance traveled from the oldest coordinate set to the most recent. Therefore the number of coordinates sets stored in the buffer must be sufficient to represent a total distance traveled that exceeds the required change in position for a heading calculation with acceptable error. With this type of buffer, a vehicle heading calculation with the desired accuracy will be possible at the time of each GNSS update, no matter the speed of the vehicle.

With an adequately sized circular buffer, there are two aspects of this invention. The first is updating the circular buffer at the correct times. At each GNSS update, the change in position of the current GNSS coordinates relative to the most recently stored GNSS coordinates is determined. If the change in position is less than a desired threshold, then the current GNSS position coordinates are not stored. When at a GNSS update, the change in position relative to the most recently stored GNSS coordinates exceeds the threshold, the circular buffer index pointing to the most recently stored coordinates is incremented, and the current GNSS position coordinates are stored at the newly indexed buffer location.

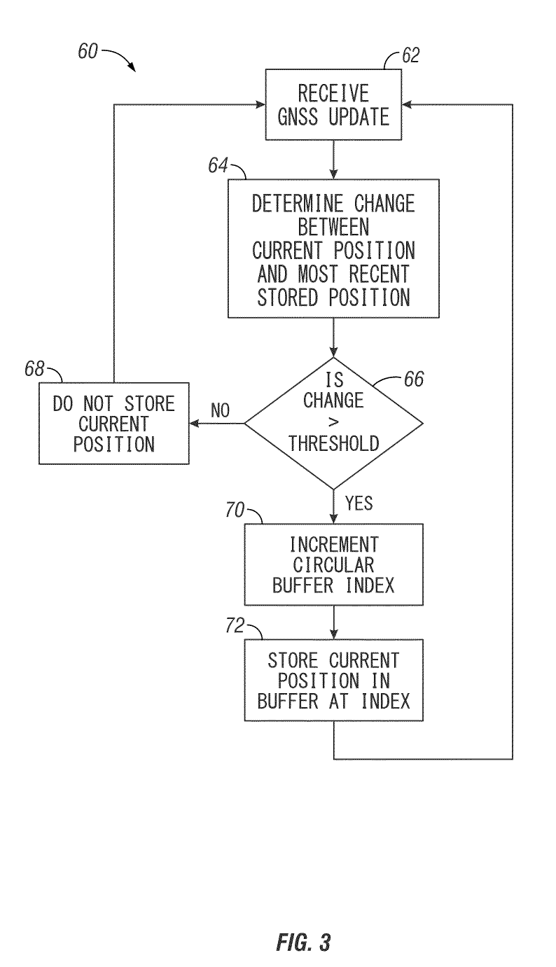

FIG. 3 illustrates one example of a method for updating the circular buffer. According to the method 60, in step 62 a GNSS update is received to provide a current position. In step 64 a determination is made of the change between the current position and the most recently stored position. In step 66 a determination is made as to whether the change is less than a set threshold. If it is, then in step 68 the current position can be discarded or not stored and the process can return to 62 to await the next GNSS update. If in step 66 the change between the current position and the most recently stored position is greater than a threshold then in step 70 a circular buffer index may be incremented. Then in step 72 the current position may be stored in the circular buffer at the circular buffer index.

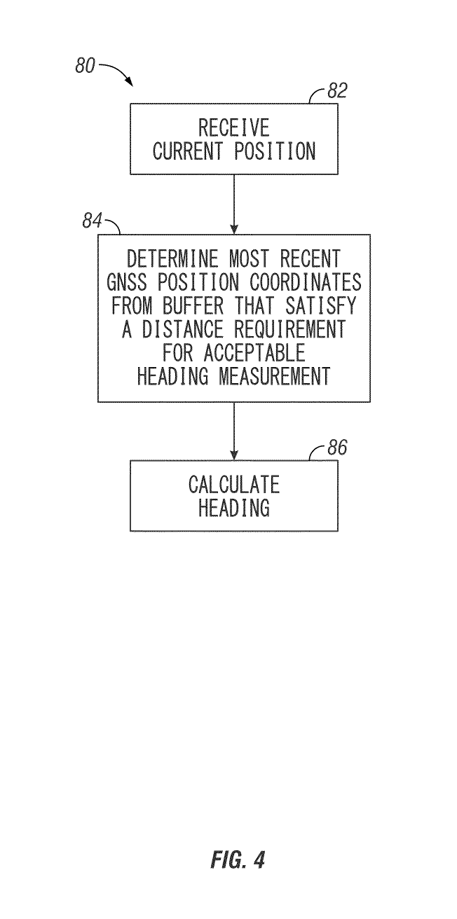

Another aspect of this invention relates to calculating each new heading measurement using the current GNSS position coordinates and the most recent GNSS position coordinates from the buffer that satisfy the distance requirement for an acceptable heading measurement. Using the most recent coordinates that satisfy the distance requirement minimizes the latency of the heading calculation. FIG. 4 illustrates a methodology 80. In step 82 the current position is received. In step 84, the most recent GNSS position coordinates from the buffer that satisfy a distance requirement for acceptable heading measurements is obtained. In step 86, the heading is calculated.

There is more than one way to find the most recent GNSS coordinates in the buffer that satisfies the distance requirement for a heading measurement. A way that tends to minimize the computation involved is by starting at the buffer location of the stored coordinates that were most recently used for a heading measurement. These GNSS coordinates satisfied the distance requirement from the GNSS position at the previous GNSS update, and can be expected to be a farther distance from the current GNSS position. Then increment the buffer index to move forward in time. The algorithm may then check to see if these more recent position coordinates, when combined with the current GNSS position coordinates, satisfy the distance requirement. If they do, then we move forward in time again within the buffer, and again check the distance requirement. This process may be repeated until the next set of position coordinates in the buffer does not satisfy the travel distance requirement for an acceptable heading measurement. Then the most recent coordinates that satisfied the distance requirement are the position coordinates that may be used.

When the speed of the vehicle is sufficient so that the distance requirement for an acceptable heading measurement is satisfied by the position change during a single GNSS update period, then the heading measurement produced by this algorithm will be the same as the normal GNSS heading measurement.

Whenever the vehicle stops, the operator may change the driveline gear direction from forward to reverse or reverse to forward. When this occurs, the GNSS coordinates in the buffer that preceded the gear direction change no longer represent previous locations along the current direction of travel with older values being farther from the current position. So after a change in the gear direction, the buffer values or indices should be changed so that the position coordinates that preceded the stopped position are no longer used. This can be done by resetting the buffer index that points to the oldest useful coordinates in the buffer to point to the coordinates representing the stopped location, or the oldest set of coordinates following the stop. The buffer will then be reinitialized with new values in the new travel direction as the vehicle travels the distance requirement for an acceptable heading measurement beyond the stopped position.

Therefore, methods, systems, and apparatus relating to navigation systems have been described. Although specific embodiments are described herein, the present invention contemplates numerous variations, options, and alternatives. For example, it is contemplated that, where used, a buffer index may be incremented before or after a GNSS position is stored in the circular buffer. It is contemplated that the heading calculation may use any GNSS position from the buffer (where used) which satisfies a distance requirement. It is contemplated that GNSS positions could be stored in the circular buffer every time they are received, or only when a change in position threshold is met. Thus, the present invention is not to be limited by or to any preferred embodiments described herein.

What is claimed is:

1. A method for determining heading for agricultural equipment operating at low speeds, the method comprising:
receiving a current GNSS position from a GNSS receiver associated with the agricultural equipment, the GNSS receiver having a single antenna;
storing a plurality of received GNSS positions;
selecting one of the plurality of received GNSS positions whose distance from the current GNSS position exceeds a threshold to provide a selected stored received GNSS position; and
calculating heading using the current GNSS position and said selected stored received GNSS position.

2. The method of claim 1 wherein the plurality of received GNSS positions are stored in a circular buffer.

3. The method of claim 1 wherein a processor determines a change in position between the current GNSS position and the selected stored received GNSS position.

4. The method of claim 1 further comprising storing the current GNSS position if there is a change in position greater than a threshold between the current GNSS position and a most recently stored GNSS position.

5. The method of claim 1 wherein the selected stored received GNSS position is a most recently stored position within the plurality of received GNSS positions that satisfies a distance requirement from the current GNSS position.

6. The method of claim 1 further comprising determining a change in gear direction after a stop and eliminating use of GNSS positions that preceded the stop from the plurality of received GNSS positions in event of the change in gear direction.

7. A control system for agricultural equipment operating at low speeds, the control system comprising:
a single antenna GNSS receiver;
a processor operatively connected to the single antenna GNSS receiver and configured to receive as input from the single antenna GNSS receiver a current GNSS position;
a memory buffer associated with the processor;
wherein the processor is configured for (a) receiving a current GNSS position from the GNSS receiver, (b) storing a plurality of received GNSS positions in the memory buffer, (c) selecting one of the plurality of received GNSS positions whose distance from the current GNSS position exceeds a threshold to provide a selected stored received GNSS position, and (d) calculating heading the current GNSS position and said selected stored received GNSS position.

8. The control system of claim 7 wherein the processor is further configured for storing the current GNSS position if there is a change in position greater than a threshold between the current GNSS position and a most recently stored GNSS position.

9. The control system of claim 7 wherein the selected stored received GNSS position is a most recently stored position within the plurality of received GNSS positions that satisfies a distance requirement from the current GNSS position.

10. The control system of claim 7 wherein the processor is further configured for determining a change in gear direction after a stop and eliminating use of GNSS positions that preceded the stop from the plurality of received GNSS positions in event of the change in gear direction.
